(19) United States
(12) Patent Application Publication
(10) Pub. No.: US 2023/0161185 A1
(43) Pub. Date: May 25, 2023

(54) FERROFLUID DISPLAY CONTROL DEVICE

(71) Applicant: Seung Hun JEONG, Ansan-si (KR)

(72) Inventor: Seung Hun JEONG, Ansan-si (KR)

(21) Appl. No.: 17/955,036

(22) Filed: Sep. 28, 2022

(30) Foreign Application Priority Data
Nov. 25, 2021 (KR) 10-2021-0164607

(51) Int. Cl. G02F 1/09; G06F 3/16; H04R 3/00; H04R 1/02

(52) U.S. Cl. CPC G02F 1/092; G06F 3/165; H04R 3/00; H04R 1/028; H04R 2420/07; H04R 2499/15

(57) ABSTRACT

The present invention relates to a ferrofluid display control device including: a storage part whose at least a front surface is made of a transparent material to store a transparent liquid and a ferrofluid therein and to display the movements of the transparent liquid and the ferrofluid; an input part disposed on one side of the storage part to detect the selection of a frequency range control input signal capable of controlling the movements of the ferrofluid; a controller for generating a magnetic field supply control signal for controlling the intensity of the magnetic field supplied to the ferrofluid; and a magnetic field supply part having an electromagnet disposed on one side of the rear surface of the storage part.

### CROSS REFERENCE TO RELATED APPLICATION OF THE INVENTION

The present application claims the benefit of Korean Patent Application No. 10-2021-0164607 filed in the Korean Intellectual Property Office on Nov. 25, 2021, the entire contents of which are incorporated herein by reference.

### BACKGROUND OF THE INVENTION

### Field of the Invention

The present invention relates to a ferrofluid display control device.

### Background of the Related Art

A ferrofluid is a new material that was invented by a NASA in the early 1960s. The ferrofluid has been used to supply a fuel to a spaceship in a weightless environment or to seal connection portions on a ship body and a space suit. Recently, the ferrofluid is used for a high-end speaker damper or for sealing a rotating shaft of a motor.

The ferrofluid is a nanotechnology wherein iron powder with extremely tiny particles, which are not seen with the naked eye, is uniformly distributed in a base solution. The nano-sized iron powder onto which a surfactant is coated does not bond, so that it has the physical properties of a liquid. Products for visually displaying the movements of the ferrofluid have been developed.

However, the display device may be complicated in configuration because cells producing a magnetic field are arranged in a given pattern. If the plurality of electromagnetic cells is arranged in the given pattern, besides, a manufacturing cost and energy consumption may be increased. As the pattern of the magnetic field is controlled by the arrangement of the cells patterned, further, the movements of the ferrofluid are not performed naturally. Accordingly, there is a need to develop a technology wherein the movements of the ferrofluid can be displayed in a simpler configuration and in an easier way.

### SUMMARY OF THE INVENTION

Accordingly, the present invention has been made in view of the above-mentioned problems occurring in the related art, and it is an object of the present invention to provide a ferrofluid display control device that is capable of displaying the movements of a ferrofluid in accordance with the magnetic field variation corresponding to the frequency range selected.

To accomplish the above-mentioned object, according to the present invention, there is provided a ferrofluid display control device including: a storage part whose at least a front surface is made of a transparent material to store a transparent liquid and a ferrofluid therein, while the transparent liquid and the ferrofluid having different specific gravities from each other and being kept in a non-mixed state, and to display the movements of the transparent liquid and the ferrofluid; an input part disposed on one side of the storage part to detect the selection of a frequency range control input signal capable of controlling the movements of the ferrofluid in proportion to the frequency range selected among a plurality of pre-determined frequency ranges; a controller for generating a magnetic field supply control signal for controlling the intensity of the magnetic field supplied to the ferrofluid in response to the frequency range control input signal detected through the input part; and a magnetic field supply part having an electromagnet disposed on one side of the rear surface of the storage part and adapted to supply the magnetic field corresponding to the input of the magnetic field supply control signal supplied from the controller to the ferrofluid.

According to the present invention, desirably, the input part may include: a frequency range control part for controlling the plurality of pre-determined frequency ranges; and an electromagnet intensity control part for controlling the intensity of the electromagnet, the frequency range control part and the electromagnet intensity control part being disposed on the front surface of the storage part.

According to the present invention, desirably, the ferrofluid display control device may further include speaker parts connected to the magnetic field supply part on one side of the storage part through wireless communication to produce the sound corresponding to the selected frequency range, so that the controller generates the magnetic field supply control signal with the intensity of the magnetic field capable of moving the ferrofluid in accordance with the sound outputted from the speaker parts in proportion to the individual volume size divided by the selected frequency range among the plurality of pre-determined frequency ranges.

According to the present invention, desirably, the controller may react to a sound source played in real time to allow the on/off time patterns of the electromagnet to be differently made from each other with pre-determined non-periodical patterns, so that if the electromagnet is turned on to supply the magnetic field to the ferrofluid, the ferrofluid, which floats on the transparent liquid, while being kept at the non-mixed state with the transparent liquid, moves to the electromagnet according to the intensity of the magnetic field, while having given directionality, and is varied in shape, and if the electromagnet is turned off to stop the supply of the magnetic field to the ferrofluid, the ferrofluid swims in a different direction from the direction of center at which the electromagnet is located in the storage part by means of inertia and gravity.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram showing a ferrofluid display control device according to the present invention;

FIG. 2 is a perspective view showing a wireless communication speaker through which the audio-visual display of a ferrofluid according to the present invention is performed;

FIG. 3 is a sectional view showing the movements of the ferrofluid corresponding to the turning on/off of an electromagnet according to the present invention; and

FIG. 4 is a perspective view showing the movements of the ferrofluid corresponding to the frequency range selected according to the present invention.

### DETAILED DESCRIPTION OF THE PREFERRED EMBODIMENTS

Terms used in this application are used to only describe specific exemplary embodiments and are not intended to restrict the present invention. An expression referencing a singular value additionally refers to a corresponding expression of the plural number, unless explicitly limited otherwise by the context. In this application, terms, such as “comprise”, “include”, or ‘have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, an explanation of the present invention will be given in detail. Before the present invention is disclosed and described, it is to be understood that the disclosed embodiments are merely exemplary of the invention, which can be embodied in various forms. Those skilled in the art will envision many other possible variations within the scope of the present invention.

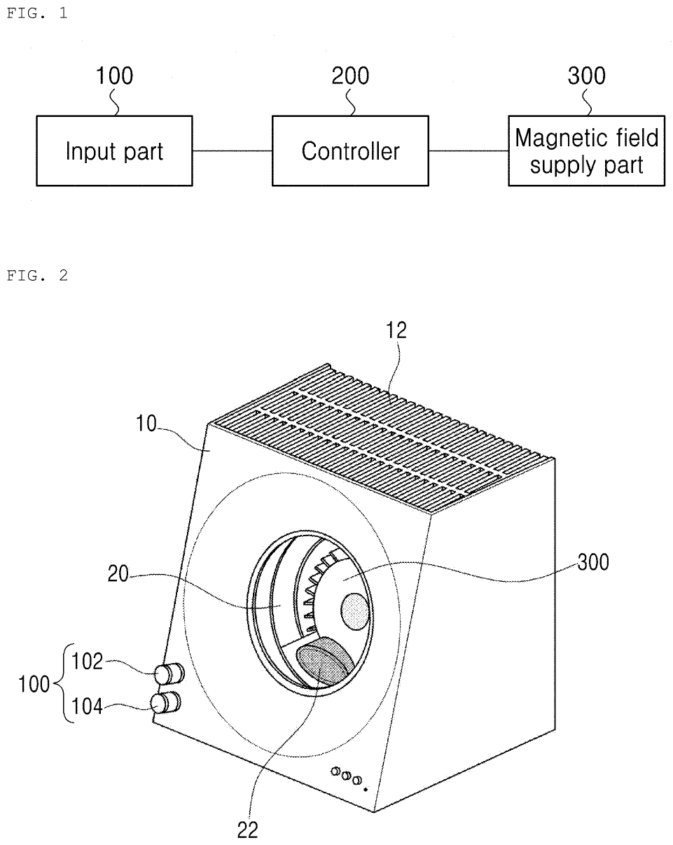

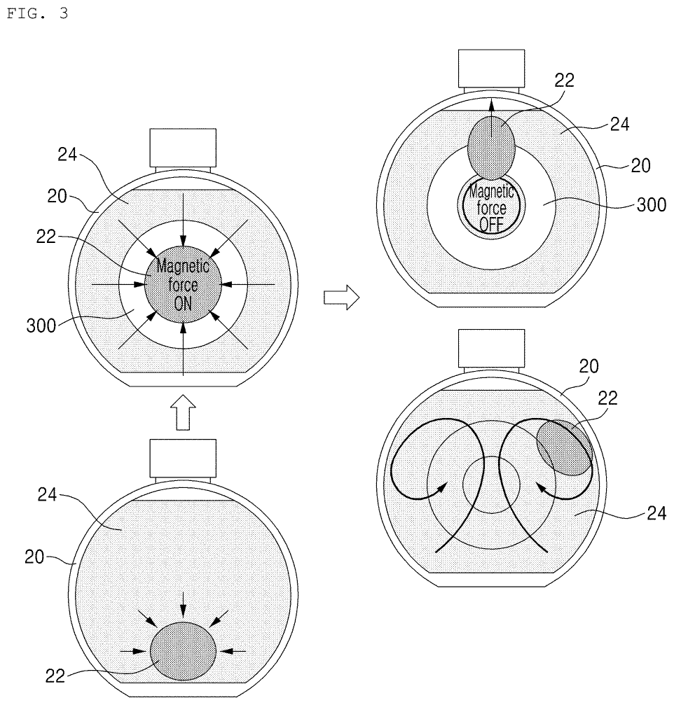

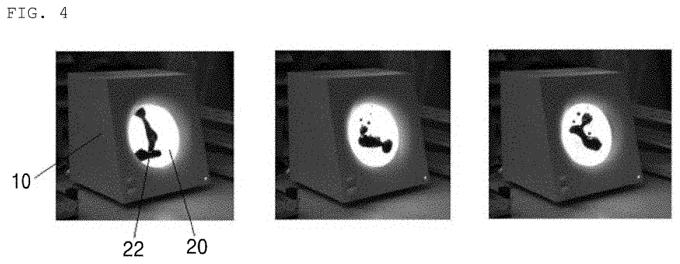

FIG. 1 is a block diagram showing a ferrofluid display control device according to the present invention, and FIG. 2 is a perspective view showing a wireless communication speaker through which the audio-visual display of a ferrofluid according to the present invention is performed, FIG. 3 is a sectional view showing the movements of the ferrofluid corresponding to the turning on/off of an electromagnet according to the present invention, and FIG. 4 is a perspective view showing the movements of the ferrofluid corresponding to the frequency range selected according to the present invention. Referring to FIGS. 1 to 4, a ferrofluid display control device according to the present invention includes a storage part 20, an input part 100, a controller 200, and a magnetic field supply part 300, and accordingly, the ferrofluid display control device naturally displays the movements of a ferrofluid 22 in accordance with changes in the magnetic field of an electromagnet included in the magnetic field supply part 300 in response to the frequency range selected through the input part 100.

The storage part 20 has at least a front surface made of a transparent material so that a transparent liquid 24 and the ferrofluid 22, which are stored therein to have different specific gravities from each other and kept in a non-mixed state, are displayed in their movements. In this case, the ferrofluid 22 includes at least one or more materials of fine iron powder, surfactants, and oil. Iron is submerged in water due to its heavy density, but the surfactants coated onto the particles of iron are uniformly distributed into the oil to make the properties of a fluid. Owing to the properties of oil lighter than water, besides, a relatively lightweight fluid may be made. The transparent liquid 24 includes ionized water. The storage part 20 has 130 ml of capacity. In this case, 8 ml of the ferrofluid 22 and 120 ml of the transparent liquid 24 are stored in the storage part 20. The capacities of the ferrofluid 22 and the transparent fluid 24 stored in the storage part 20 are controlled, and the specific gravities of the ferrofluid 22 and the transparent fluid 24 are kept similar to each other, so that the ferrofluid 22 and the transparent fluid 24 become in a state similar to the weightless state in the air, thereby allowing the heavy ferrofluid 22 to easily move even with an extremely low magnetic force. The ferrofluid 22 having a slightly higher specific gravity than the transparent liquid 24 is submerged slowly by gravity. If the ferrofluid 22 is lifted up by means of a magnetic force for a given period of time, it moves in a direction of an electromagnet core. The ferrofluid 22 continuously moves in the advancing direction thereof by inertia and is then submerged again by gravity. As the ferrofluid 22 moves, it changes the flow of the transparent liquid 24, which is not seen, and according to the flow of the transparent liquid 24, the ferrofluid 22 is displayed as if it moves in a random direction, not in a direction of gravity. The transparent liquid 24 generates the flow by fluid mechanics owing to the movements of the ferrofluid 22 that are generated by the magnetic field of the electromagnet. The ferrofluid 22 moves along the flow of the transparent liquid 24 to thus have given directionality, so that it makes a moving pattern related to the directionality. Further, the operating pattern of the electromagnet determines the moving direction of the ferrofluid 22, and through the random components of the music played, free movements in every direction of the ferrofluid 22 may be displayed. The ferrofluid 22 does not move simply in the storage part 20, but it makes different moving patterns every time by irregular components, that is, types of sound sources and fluid mechanics, thereby achieving aesthetic effects. Owing to the time difference caused by turning on/off the electromagnet, the ferrofluid 22 moves to more various directions and shapes, and further, it moves in accordance with the music as if it dances.

If the electromagnet is turned off, the ferrofluid 22 moves downward by the influence of gravity, while being not continuously floating on the transparent liquid 24. Accordingly, the specific gravity of the ferrofluid 22 is somewhat higher than that of the transparent liquid 24. For example, a specific gravity ratio of the transparent liquid 24 to the ferrofluid 22 is 4.5 to 5.5. If the electromagnet is turned on, the ferrofluid 22, which has the specific gravity relatively higher than that of the transparent liquid 24, is easily lifted up by the magnetic force of the electromagnet. Even if the electromagnet is turned off, in this case, the ferrofluid 22, which becomes relatively lightweight, moves freely by inertia in a similar state to the weightless state in the air and continuously moves to the corresponding direction.

If the specific gravity of the transparent liquid 24 is lower than 4.5 and that of the ferrofluid 22 is higher than 5.5, the ferrofluid 22 is submergedly placed flattedly on bottom of the storage part 20 by the specific gravity difference between the ferrofluid 22 and the transparent liquid 24. In specific, if the specific gravity of the ferrofluid 22 is substantially high, a relative pressure is generated by the specific gravity difference between the ferrofluid 22 and the transparent liquid 24, and as a downward moving speed becomes high by gravity, there is a limitation in performing natural movements of the ferrofluid 22. For example, if the electromagnet is turned on, the ferrofluid 22, which is relatively heavier than the transparent liquid 24, is not easily lifted up by the magnetic force of the electromagnet. Further, if the electromagnet is turned off, the ferrofluid 22, which is relatively heavier than the transparent liquid 24, is easily submergedly placed on the bottom of the storage part 20. Contrarily, if the specific gravity of the ferrofluid 22 is substantially low, the ferrofluid 22 is relatively light so that it floats up in the transparent liquid 24 and has a slow downward moving speed by the buoyancy in the transparent liquid 24, thereby making it hard to perform the control thereof. So as to control the specific gravity of the transparent liquid 24, a high specific gravity hydrophilic solution is mixed with the transparent liquid 24 to a given ratio to a state proper for controlling the movements of the ferrofluid 22.

Generally, the ferrofluid 22 is heavier than the transparent liquid 24, and only through a device for arranging a large number of small electromagnets, accordingly, the ferrofluid 22 can move in every direction. In this case, however, the movements of the ferrofluid 22 may be a little unnatural, and a large amount of power is consumed due to the large number of small electromagnets. In addition, the design may be complicatedly made to undesirably need a high manufacturing cost. Accordingly, there is a need to set the specific gravity ratio of the transparent liquid 24 to the ferrofluid 22 in consideration of the magnetic force of the electromagnet.

According to the present invention, the specific gravity difference between the transparent liquid 24 and the ferrofluid 22 is set to allow the ferrofluid 22 to easily react to the magnetic force of the electromagnet, and accordingly, the ferrofluid 22 is easily lifted up in response to even a small magnetic force of the electromagnet, so that the ferrofluid 22 can move in every direction randomly only through the electromagnet. As the movements of the ferrofluid 22 are performed by only one electromagnet, further, an amount of power consumed is decreased, and the design is simpler than that needed for the structure in the plurality of small electromagnets are arranged, thereby achieving a low manufacturing cost. In addition, the ferrofluid 22 moves naturally and beautifully by fluid mechanics.

Further, the storage part 20 includes a glass container subjected to super-hydrophilic coating. The ionization of the transparent liquid 24 prevents the ferrofluid 22 from attaching to the surface of the glass container. A hydrophilic treatment step of the glass container is as follows. First, remaining pollutants (organic or inorganic pollutants) are removed upon the manufacturing of the glass container, and next, etching for uniformizing the surface roughness of the glass container is performed. After that, hydrophilic coating is applied to the surface of the glass container and is then dried, and next, the glass container is kept wet with the transparent liquid 24 for a given period of time. Lastly, the ferrofluid 22 is put into the glass container.

The surface of the glass container subjected to the hydrophilic coating becomes wet by the ionized water whose polarity is optimized and does not bond basically with non-polar oil. Further, the storage part 20 includes an LED lamp.

In addition, the storage part 20 whose portion is included in a body 10. If the storage part 20 is disposed separately from the body 10, the body 10 is made of a different material from the material of the storage part 20. For example, the body 10 has the shape of a case made of an ABS material. If necessary, however, the storage part 20 and the body 10 are provided integrally with each other. If the storage part 20 is disposed inside the body 10, function buttons as well as the input part 100 are provided on the front surface of the body 10. In this case, the function buttons include control buttons such as power, pairing, playing, volume, track selection, and the like and display lamps. Speaker parts 12 are located on top of the body 10. A terminal panel including a power adapter is located on the rear of the body 10. For example, the terminal panel includes a power switch, an output terminal having 3.5 mm line out stereo connector, a firmware upgrade USB terminal, and the like. Further, the terminal panel includes input/output terminals such as RCA, S/PDIF, MIDI, DMX, and the like.

The input part 100 functions to control the frequency range of a sound source. In this case, the sound source is received from the outside. The sound source is divided into a plurality of frequency ranges pre-determined by the input part 100, and the intensity of the magnetic field is determined in proportion to the volume of the frequency range selected. In specific, the magnetic field is generated only from the frequency range selected among the plurality of frequency ranges divided through the input part 100. The input part 100 is disposed on one side of the storage part 20 to detect the selection of a frequency range control input signal capable of controlling the movements of the ferrofluid 22 in proportion to the frequency range selected among the plurality of pre-determined frequency ranges. The input part 100 may include a plurality of control parts. For example, the input part 100 includes a frequency range control part 102 for controlling the selection and storage of the plurality of pre-determined frequency ranges and an electromagnet intensity control part 104 for controlling the intensity of the electromagnet, which are disposed on the front surface of the storage part 20. Further, the input part 100 includes a push switch adapted to analyze the metadata of the sound source played and store the frequency range selected by a user and the electromagnet intensity corresponding to the selected frequency range. The stored data can operate as the frequency range and the intensity of the electromagnet selected automatically according to the sound source played. That is, a song's name is extracted from the metadata of the sound source transmitted by using digital signals, and the frequency range and the intensity of the electromagnet selected according to the user's preference are stored together with the song's name. When the sound source is played later, the current song's name is compared automatically with the stored song's name, and accordingly, the data can operate as the stored frequency range and intensity of the electromagnet.

The ferrofluid 22 does not move by the entire volume of the sound source, but moves by the intensity of the electromagnet that is determined in proportion to the individual volume sizes divided by frequency range. In the case of the sound source made by various musical instruments, if the frequency range is not divided, the entire frequency range binds together so that the electromagnet, which operates in proportion to the volume sizes, is hard to correspond to the rhythm and melody of the music. In the case of the sound source made only by a musical instrument or voice, the entire frequency range mode is selected (by a frequency range selection dial) and operates. The sound source is divided into 7-step frequency range (63 Hz, 160 Hz, 400 Hz, 1 kHz, 2.5 kHz, 6.25 kHz, and 16 kHz) from a high-pitched tone to a low-pitched tone. Further, the resolution of the frequency range is enhanced to thus divide the sound source into seven or more steps, thereby improving the accuracy in operating the electromagnet. The input part 100 includes a frequency range control module for dividing the sound source into the plurality of frequency ranges to operate the electromagnet in proportion to the frequency range selected. In this case, the frequency range control module includes a graphic equalizer IC for dividing audio spectrum into 7 frequency bands (63 Hz, 160 Hz, 400 Hz, 1 kHz, 2.5 kHz, 6.25 kHz, and 16 kHz). The 7 frequency ranges whose peaks are detected and multiplexed as outputs so that the amplitudes of the respective bands are displayed to the form of DC.

Further, the volume values of the respective frequency ranges are measured in real time. Besides, the user can select his or her desired frequency range. If the desired frequency range is selected through the frequency range control part 102, the operation of the electromagnet is controlled to allow the volume size of the selected frequency range to be proportional to the intensity of the magnetic force of the electromagnet, and accordingly, the movements of the ferrofluid 22 corresponding to the operation of the electromagnet are displayed. The electromagnet moving the ferrofluid 22 does not move by the entire volume of the sound source, but moves by the intensity determined in proportion to the individual volume sizes divided by frequency range. If numbers of frequency ranges are high, the pitch of a tone becomes high. For example, if it is desired that the movements of the ferrofluid 22 react to the bass drum sounds of the sound source played, the low frequency range is selected. That is, the bass musical instrument producing a low-pitched tone is in a low frequency range, and a violin producing a high-pitched tone is in a high frequency range.

For example, the volume sizes (10 to 100) of the selected frequency range are proportional to the intensities (10 to 100) of the magnetic force of the electromagnet. That is, if the volume size of the sound source played is small in the range between 10 and 20, the intensity of the magnetic force of the electromagnet is weakened in the range between 10 and 20 in proportion to the volume size of the sound source, so that the ferrofluid 22 moves weakly and slowly. Contrarily, if the volume size of the sound source played is large in the range between 10 and 90, the intensity of the magnetic force of the electromagnet becomes strong in the range between 10 and 90 in proportion to the volume size of the sound source, so that the ferrofluid 22 moves strongly and fast.

As mentioned above, the sound source is divided into the 7-step frequency range. In the state, the user selects the frequency range corresponding to the sound source. Accordingly, the electromagnet operates to allow the volume size of the selected frequency range to be proportional to the size of the magnetic force thereof. That is, the movements of the ferrofluid 22 can be made according to the user's selected frequency range. The ferrofluid 22 moves as if it is alive in a weightless space, which creates the user's curiosity and imagination. Further, the user can observe his or her interaction with the ferrofluid 22 reacting to the sound source selected by him or her in real time. Besides, the frequency range and the intensity of the electromagnet are selected directly by the user, and accordingly, the movements of the ferrofluid 22 can be made according to his or her preference.

The electromagnet intensity control part 104 is provided to allow the magnetic force to be divided into 20 steps, thereby controlling the intensity of the magnetic force to the maximum value. Accordingly, the user can select the frequency range and the intensity of the electromagnet according to his or her preference, so that the movements of the ferrofluid 22 can be controlled through the intensity of the magnetic force determined in proportion to the volume size of the selected frequency range.

The controller 200 generates a magnetic field supply control signal for controlling the intensity of the magnetic field supplied to the ferrofluid 22 in response to a frequency range control input signal detected from the input part 100. That is, the controller 200 determines the intensity of the magnetic field in proportion to the individual volume size divided by frequency range and controls the movements of the ferrofluid 22. The controller 200 performs the signal analysis related to the on/off control of the electromagnet by frequency range and the control operations related to the signal analysis according to pre-determined control conditions to thus achieve the natural movements of the ferrofluid 22 contained in the transparent liquid 24 on the condition that the movements of the ferrofluid 22 are controlled in proportion to the selected frequency range. The controller 200 performs operation and processing by a processor of an information processing device and represents a logical part of a program performing a specific function on a computer, which is implemented in software, hardware, and the like. For example, the information processing device includes a control computer such as a control panel, a laptop, a personal computer, a handheld computer, a personal digital assistant (PDA), a cellular phone, a smart device, a tablet, and the like. Further, the controller 200 includes a memory for storing the data related to the on/off control of the electromagnet and the control of the movements of the ferrofluid 22 on the control conditions of the movements of the ferrofluid 22 by frequency range. The memory is adapted to store the program control and information processing related to the movement control of the ferrofluid 22 and the related data and program and includes various types of memories such as a high-speed random access memory, a magnetic disc storage device, a flash memory device, a non-volatile solid-state memory device, and the like.

The controller 200 adjusts the intensity of the electromagnet and the on/off time of the electromagnet to control the movements of the ferrofluid 22. For example, the controller 200 adjusts the intensity of the electromagnet to a maximum value in the state where the intensity of the magnetic force is determined in proportion to the volume size of the frequency range selected through the input part 100 and thus controls the movements of the ferrofluid 22. If necessary, the controller 200 automatically collects the ferrofluid 22 scattering in the storage part 20. That is, the controller 200 has a function of ferrofluid calibration to thus perform the calibration of the ferrofluid 22. Further, the controller 200 controls the on/off time of the electromagnet to be differently set from each other with pre-determined non-periodical patterns. The intensity of the electromagnet and the distribution range of the magnetic field are controlled by means of the difference of the on/off time when the electromagnet operates and stops.

If the electromagnet is turned on to supply a magnetic field to the ferrofluid 22, the ferrofluid 22, which floats on the transparent liquid 24, while being kept at the non-mixed state with the transparent liquid 24, moves to the electromagnet according to the intensity of the magnetic field, while having directionality, and is varied in shape. Contrarily, if the electromagnet is turned off to stop the supply of the magnetic field to the ferrofluid 22, the ferrofluid 22 swims in a different direction from the direction of center at which the electromagnet is located in the storage part 20 by means of inertia and gravity.

The magnetic field supply part 300 includes the electromagnet disposed on one side of the rear surface of the storage part 20 and supplies the magnetic field corresponding to the input of a magnetic field supply control signal from the controller 200 to the ferrofluid 22. If necessary, the electromagnet is customizedly made according to pre-determined methods and processes. The electromagnet is made in consideration of the thickness of a coil, the number of coil turns, the entire resistance value, the size of a core, and the shape of a housing to thus provide appropriate magnetic force and distribution of the magnetic field. If the electromagnet operates to supply the magnetic field to the ferrofluid 22, the ferrofluid 22 moves to the electromagnet in the transparent liquid 24, while having directionality, and displays the image corresponding to the movement.

Referring to FIG. 2, further, the ferrofluid display control device according to the present invention is configured to allow the audio-visual display of the ferrofluid 22 to be provided to the form of a wireless communication speaker. In this case, the ferrofluid display control device according to the present invention further includes the speaker parts 12 connected to the magnetic field supply part 300 on one side of the storage part 20 through wireless communication to produce the sound corresponding to the selected frequency range. The speaker parts 12 are provided plurally, and passive radiators for bass boost may be provided. The wireless communication may include Bluetooth. In this case, the controller 200 receives the sound source from the outside through the wireless communication, transmits the received sound source to the speaker parts 12, and controls the shape of the magnetic field supplied from the magnetic field supply part 300 where the sound source is converted into a magnetic field pattern signal to the ferrofluid 22. That is, the controller 200 generates the magnetic field supply control signal with the intensity of the magnetic field capable of moving the ferrofluid 22 in accordance with the sound outputted from the speaker parts 12 in proportion to the individual volume size divided by the selected frequency range among the plurality of frequency ranges. At least any one of the intensity of the magnetic field, the frequency of the magnetic field, and the pattern of the magnetic field may be changed according to at least any one of the amount of electric current supplied to the speaker parts 12, the size of the sound outputted from the speaker parts 12, and the bit in the sound. Like this, the ferrofluid display control device according to the present invention is provided to the form of the audio-visualizer Bluetooth speaker using the ferrofluid 22, so that it displays the movements of the ferrofluid 22 as if the ferrofluid 22 dances. In the case where the ferrofluid display control device is provided to the form of the Bluetooth speaker, it may further include function buttons such as play, pause, pairing, volume selection, track selection, and the like.

Referring to FIGS. 3 and 4, the transparent liquid 24 generates flows caused by fluid mechanics through the ferrofluid 22 moving by the magnetic force of the electromagnet, and the ferrofluid 22 moves along the flows of the transparent liquid 24 and has the directionality. In such movements, the on/off time of the electromagnet are different from each other in the pre-determined non-periodical patterns, and the ferrofluid 22 floating on the transparent liquid 24 is attractedly pulled again to the center and moves again in another direction. The non-periodical patterns of the on/off time of the electromagnet are critical elements making the ferrofluid 22 and the transparent liquid 24 more freely move, thereby producing the random movements and patterns of the ferrofluid 22. That is, the non-periodical patterns of the on/off time of the electromagnet do not determine simply the moving directions of the ferrofluid 22, but produces the random movements of the ferrofluid 22 in various patterns caused by the fluid mechanics.

Further, existing volume unit (VU) meters, equalizer viewers, and sound visualizers are displayed monotonically by means of LED lighting or graphic. According to the present invention, however, the random movements and patterns of the ferrofluid 22 are created by means of the physical phenomenon caused by the fluid mechanics, thereby removing the problem of the monotony. Moreover, the ferrofluid display control device according to the present invention may be used as a component of a professional sound system as it has a visualizing function as the original function of the VU meters, equalizer viewers, and sound visualizers.

As mentioned above, the ferrofluid display control device according to the present invention is configured to allow the specific gravities of the ferrofluid 22 and the transparent liquid 24 to be kept to the similar values to each other to produce the movements of the ferrofluid 22 efficiently by means of the single electromagnet. Further, the capacity of the ferrofluid 22 is adjusted so that the ferrofluid 22 reacting to the frequency range can freely move as if it is in the weightless state, and the shape and structure of the electromagnet are improved to allow the ferrofluid 22 to move in the random direction by the fluid mechanics using the gravity and the magnetic force, thereby providing an audio control ferrofluid specific gravity difference visualization display device. In specific, the movements of the ferrofluid 22 can be made in the random direction (in every direction) through the single electromagnet according to the selected frequency range.

The ferrofluid display control device according to the present invention may be configured as a mount type display device in which the storage part 20 with the ferrofluid 22 displayed therein is separated from the controller 200 may be provided. For example, a plurality of display devices operate simultaneously to react to their respective individual frequency ranges, and otherwise, the display devices have to use only a single container. Such a design enables the manufacturing cost to be greatly decreased, thereby making a relatively cheaper popular product.

The ferrofluid 22 basically has a black color. However, if pigments having metallic colors are coated onto the surface of the ferrofluid 22, the ferrofluid 22 has various colors. The coloring of the ferrofluid 22 is determined in consideration of a purchaser's individual preference, and if the ferrofluid display control device according to the present invention is made for the promotion of a company, the coloring of the ferrofluid 22 is determined to efficiently express the identification of the company.

Further, a water ferrofluid 22 may be used as the ferrofluid 22 so as to achieve more efficient production. The water ferrofluid 22 may be used in a general plastic container, and accordingly, the container may be freely molded to various shapes. Besides, there is no need to perform additional surface treatment, unlike the glass container, thereby enabling the production cost to be greatly reduced.

Moreover, the ferrofluid display control device according to the present invention is configured to allow the sound outputted from the speaker parts 12 connected wirelessly or wiredly to the sound source and the movements of the ferrofluid 22 controlled in proportion to the selected frequency range to be produced, so that the volume sizes outputted by the frequency range selected by the user audio-visualizedly match the various patterns made by the natural random movements of the ferrofluid 22, thereby transmitting the authentic effects and functioning as an acoustic auxiliary device for acoustic engineers, musicians, and the like.

The present invention may be modified in various ways and may have several exemplary embodiments. Accordingly, it should be understood that the invention covers all the modifications, equivalents, and replacements within the idea and technical scope of the invention. Therefore, the present invention is not to be restricted by the embodiment but only by the appended claims.

What is claimed is:

1. A ferrofluid display control device comprising:
a storage part whose at least a front surface is made of a transparent material to store a transparent liquid and a ferrofluid therein, while the transparent liquid and the ferrofluid having different specific gravities from each other and being kept in a non-mixed state, and to display the movements of the transparent liquid and the ferrofluid;
an input part disposed on one side of the storage part to detect the selection of a frequency range control input signal capable of controlling the movements of the ferrofluid in proportion to the frequency range selected among a plurality of pre-determined frequency ranges;
a controller for generating a magnetic field supply control signal for controlling the intensity of the magnetic field supplied to the ferrofluid in response to the frequency range control input signal detected through the input part; and
a magnetic field supply part having an electromagnet disposed on one side of the rear surface of the storage part and adapted to supply the magnetic field corresponding to the input of the magnetic field supply control signal supplied from the controller to the ferrofluid.

2. The ferrofluid display control device according to claim 1, wherein the input part comprises:
a frequency range control part for controlling the plurality of pre-determined frequency ranges; and
an electromagnet intensity control part for controlling the intensity of the electromagnet, the frequency range control part and the electromagnet intensity control part being disposed on the front surface of the storage part.

3. The ferrofluid display control device according to claim 1, further comprising speaker parts connected to the magnetic field supply part on one side of the storage part through wireless communication to produce the sound corresponding to the selected frequency range, so that the controller generates the magnetic field supply control signal with the intensity of the magnetic field capable of moving the ferrofluid in accordance with the sound outputted from the speaker parts in proportion to the individual volume size divided by the selected frequency range among the plurality of pre-determined frequency ranges.

4. The ferrofluid display control device according to claim 1, wherein the controller reacts to a sound source played in real time to allow the on/off time patterns of the electromagnet to be differently made from each other with pre-determined non-periodical patterns, so that if the electromagnet is turned on to supply the magnetic field to the ferrofluid, the ferrofluid, which floats on the transparent liquid, while being kept at the non-mixed state with the transparent liquid, moves to the electromagnet according to the intensity of the magnetic field, while having given directionality, and is varied in shape, and if the electromagnet is turned off to stop the supply of the magnetic field to the ferrofluid, the ferrofluid swims in a different direction from the direction of center at which the electromagnet is located in the storage part by means of inertia and gravity.
